(19) United States
(12) Patent Application Publication
(10) Pub. No.: US 2006/0004885 A1
(43) Pub. Date: Jan. 5, 2006

(54) Multiple writer support in an OLAP environment

(75) Inventors: Igor Lubashev, Cambridge, MA (US); James Carey, Brookline, MA (US); Albert Hopeman, Arlington, MA (US); Bruce Golbus, Waban, MA (US); Ekrem Soylemez, Arlington, MA (US); Zhiqi Qiu, Waltham, MA (US)

Correspondence Address: Edward A. Pennington;Swidler Berlin Shereff Friedman, LLP, Suite 300, 3000 K Street, NW, Washington, DC, 20007-5116, US

(73) Assignee: ORACLE INTERNATIONAL CORPORATION, REDWOOD SHORES, CA (US)

(21) Appl. No.: 10/881,174

(22) Filed: Jun. 30, 2004

(51) Int. Cl. G06F 17/30

(52) U.S. Cl. 707/203

(57) ABSTRACT

Multiple writers can make permanent changes to data objects, while the performance is improved and data consistency is ensured. A database management system comprises a database containing a plurality of objects, and, possibly, a plurality of analytic workspaces, each analytic workspace containing at least some of the plurality of objects in the database, wherein changes made to a an object in a database private view are not written to a corresponding object in the database unless write access on the object has been given to the database private view, and wherein the database management system is operable to give write access on each of the plurality of objects in the database to database private views individually.

### FIELD OF THE INVENTION

The present invention relates to a system and method for consistent handling of concurrent data modification by multiple users in a database management system.

### BACKGROUND OF THE INVENTION

Online Analytical Processing (OLAP) is a category of software tools that provides analysis of data stored in a database. OLAP tools enable users to analyze different dimensions of multidimensional data. For example, OLAP may provide time series and trend analysis views. OLAP often is used in database management. An OLAP system is typically used to provide decision support services, such as forecasting, financial modeling, and what-if analysis. In performing what if analysis, an OLAP system typically performs at least three operations: (1) it retrieves historical data from a databases; (2) it changes the data in accordance with a what-if scenario posed by the user; and (3) based on the changed data, it determines what other data is changed. What-if analysis is a powerful tool because it allows a user to forecast how a change in one area may affect another. For example, a user may use what-if analysis to predict how sales in a region may change if the sales force is increased by ten percent.

A typical OLAP system includes an OLAP server, which sits between a client and a database management systems (DBMS). The OLAP server understands how data is organized in the database and has special functions for analyzing the data.

In OLAP systems, one type of OLAP object that is useful for analyzing information is a Multidimensional Cube, also known as an OLAP Measure. While a mathematical cube has exactly three dimensions, an OLAP cube may have more than three dimensions, as many as 8 or 10 dimensions are common. Many OLAP applications store information in several related cubes. For example, an application can store sales data in three cubes named Sales, UnitsSold, and Profits, and each cube may be have three dimensions: Time, Product, and Geography.

Some applications find it efficient and useful to further partition large cubes into several smaller ones. This partitioning can be used to separate information by year, for example. Hence, in the example above, the application may want to sub-partition all cubes along the time dimension by year. If the Time dimension contains data for 2000-2003, each cube dimensioned by year would be partitioned into four sub-cubes.

As noted above, one of the operations performed in a what-if analysis is to change the retrieved historical data. This change typically is not an actual change but a proposed “what-if” change. Because it is not an actual change to the data in the database, only the user making the change can see it. All other users still see the original data. OLAP systems allow different users to make private “what-if” changes to the data in a way that those changes are never made permanent. Many OLAP applications, however, have a need to distribute the ability to make permanent changes to OLAP data among users. Conventional OLAP systems are restricted in that they only allow a single writer to operate on an OLAP container (also know as Analytic Workspace or analytic workspace) at a time. Thus, conventional systems may require dividing the smaller cubes into different containers, resulting in a duplication of the structural data between these containers.

There are many reasons why an application may want to an ability to distribute making permanent changes to OLAP data among users. In many cases, there is a need to distribute nightly builds of the data to many processors, even if the application itself is not multi-threaded. By allowing multiple sessions to modify data in non-overlapping regions and make those changes permanent, it is possible to distribute the calculations to multiple processors. It is also possible that several users may desire to make independent changes to different cubes or sub-cubes. In the conventional single-writer model, those users would not be able to proceed concurrently.

Performance of a conventional application that distributes the cubes and sub-cubes to different containers (AWs) may also be a problem. In some cases it is possible to architect an application such that the data is stored in separate data areas. However, in many cases, doing so greatly increases the complexity of the application and causes duplication of structural data. In all cases where the structural data is duplicated, it is necessary for the application to make sure that changes affecting the structural data in one container are replicated to all other containers, which is a complex and daunting task.

Some conventional OLAP systems, such as ESSBASE® from HYPERION® and MS ANALYSIS SERVICES® from MICROSOFT®, have included some form of multiple writer support in the past, but many of these applications have not included sufficient protections to prevent users from making mistakes and overwriting each other's changes (the “lost update” problem). Such mistakes can often lead to inconsistent and erroneous OLAP data being stored. For example, if two users, unaware of each other, inadvertently decide to make persistent changes to the same data, unless the system is able to detect and prevent such an attempt, the user who made the persistent changes last may overwrite some but not all changes made by the other user, which would result in inconsistent data.

Thus, a need arises for an OLAP system which provides the capability for multiple writers to make permanent changes to OLAP data while providing improved performance and ensuring data consistency.

### SUMMARY OF THE INVENTION

While the present invention is implemented and described in the context of an OLAP database system, it is not limited to OLAP database systems and can be applied to any database management system. While the description of the invention refers to data residing in OLAP objects, the invention equally applies to data stored in other types of objects in non-OLAP databases (for example, indexes, procedures, etc. in relational databases). The discussion of the invention in the OLAP case mentions Analytic Workspaces, which are containers of OLAP objects in Oracle OLAP database system. Other database systems may or may not have such object containers, but the invention can also be used there, as long as the database system contains a plurality of objects that contain data.

The present invention provides the capability for multiple writers to make permanent changes to OLAP data while providing improved performance and ensuring data consistency. The present invention allows the application to store multiple OLAP objects in a single container, such that each OLAP object may be permanently modified by a session concurrent with another OLAP object in the same container being permanently modified by a different session. By allowing the OLAP objects within the container to be modified independently, the present invention eliminates much of the complication of having multiple containers (Analytic Workspaces) and the necessary duplication of data the multiple containers require. Moreover, since the OLAP objects in a single container share structural information, the structural information is automatically kept consistent for all OLAP objects in the container.

In one embodiment of the present invention, a database management system comprises a database containing a plurality of objects, and a plurality of database private views, each database private view containing a view of at least some of the plurality of objects in the database, wherein a view of an object in a database private view is based on one of the plurality of versions of the corresponding object in the database; and wherein changes made to a view of an object in a database private view are not written to the corresponding object in the database unless write access on the object has been given to the database private view, and wherein the database management system is operable to give write access on each of the plurality of objects in the database to database private views individually.

In one aspect of the present invention, the database management system is operable to give write access on an object upon request from a user of a database private view. The database management system is further operable to determine whether write access on the object can be given, in response to the request from the user of the database private view. The database management system is further operable to give write access on an object to a database private view that already contains a plurality of changes made to that object's view. The database management system is further operable to preserve changes made to an object's view, while giving write access on the object to a database private view, so that these changes, along with a plurality of further changes, can be written to that object in the database. The database management system is further operable to determine whether write access on the object can be given by determining whether the write access on the object has already been given to the user of the database private view, by determining whether the write access on the object has already been given to a user of another database private view, and by determining whether data in the object is a latest version. The database management system is further operable to refresh a view of an object in a database private view with another version of the object in the database. The database management system is further operable to refresh a view of an object in a database private view with the latest version of the object in the database. The database management system is further operable to undo changes made in a view of an object in a database private view. The database management system is further operable to give write access on an object in the database while preventing other database private views from obtaining write access on at least one other object in the database. The database management system is further operable to remove write access on a database object to which write access has been given. Each object is a variable, a measure, a cube, a dimension, a formula, a program, a procedure, an aggregation plan, a model, a relation, saved selection, a worksheet, a table, an index, an abstract data type, or a LOB (large object block).

In one embodiment of the present invention, a database management system, in which an online analytical processing system is implemented, comprises a plurality of database data structures storing a plurality of online analytical processing objects, a plurality of database management routines operable to access the database data structures, and a plurality of online analytical processing tools operable to perform online analytical processing functions on the online analytical processing objects using the database management routines.

In one aspect of the present invention, the database management system is a relational database management system. The database data structures include database data tables and binary large objects. At least some of the online analytical processing objects are stored in binary large objects. Each binary large object stores information relating to only one online analytical processing object. The database data tables store information about the state of the online analytical processing system.

In one aspect of the present invention, the plurality of online analytical processing objects implement an online analytical processing database containing a plurality of objects, and the plurality of database data structures further store a plurality of database private views, each database private view containing a view of at least some of the plurality of objects in the online analytical processing database, wherein changes made to a view of an object in a database private view are not written to a corresponding object in the online analytical processing database unless write access on the object has been given to the user of the database private view, and wherein the online analytical processing system is operable to give write access on each of the plurality of objects in the online analytical processing database to database private views individually. The online analytical processing system is operable to give write access on an object upon request from a user of a database private view. The online analytical processing system is further operable to determine whether write access on the object can be given, in response to the request from a user of the database private view. The online analytical processing system is further operable to give write access on an object to a database private view that already contains a plurality of changes made to that object's view. The online analytical processing system is further operable to preserve changes made in an object's view, while giving write access on the object to a database private view, so that these changes, along with a plurality of further changes, can be written to that object in the online analytical processing database. The online analytical processing system is further operable to determine whether write access on the object can be given by determining whether write access on the object has already been given to the database private view, by determining whether write access on the object has already been given to another database private view, and by determining whether data in the object is a latest version. The online analytical processing system is further operable to refresh a view of an object in a database private view with another version of the object in the online analytical processing database. The online analytical processing system is further operable to refresh a view of an object in a database private view with the latest version of the object in the online analytical processing database. The online analytical processing system is further operable to undo changes made in a view of an object in a database private view. The online analytical processing system is further operable to give write access on an object in the online analytical processing database while preventing other database private views from obtaining write access on at least one other object in the online analytical processing database. The online analytical processing system is further operable to remove write access on an object in the online analytical processing database to which write access has been given. Each object is a variable, a measure, a cube, a dimension, a formula, a program, a procedure, an aggregation plan, a model, a relation, saved selection, a worksheet, a table, an index, an abstract data type, or a LOB (large object block).

### BRIEF DESCRIPTION OF THE DRAWINGS

FIG. 1 is an exemplary block diagram of Online Analytical Processing (OLAP) database system.

FIG. 2 is an example of a usage of the multiwriter features of the present invention in the system shown in FIG. 1.

FIG. 3 is an example of a usage of the multiwriter features of the present invention in the system shown in FIG. 1.

FIG. 4 is an example of a usage of the multiwriter features of the present invention in the system shown in FIG. 1.

FIG. 5 is an example of a usage of the multiwriter features of the present invention in the system shown in FIG. 1.

FIG. 6 is an example of a usage of the multiwriter features of the present invention in the system shown in FIG. 1.

FIG. 7 is an example of a usage of the multiwriter features of the present invention in the system shown in FIG. 1.

FIG. 8 is an exemplary flow diagram of a process of determining whether a user can acquire an object.

FIG. 9 is an exemplary block diagram of a database management system, in which the OLAP functionality of the present invention may be implemented.

FIG. 10 is an exemplary illustration of a data structure that may be used to store analytic workspaces.

FIG. 11 is an exemplary illustration of a data structure that may be used to store analytic workspaces.

FIG. 12 is an exemplary illustration of a data structure that may be used to store analytic workspaces.

FIG. 13 is an exemplary illustration of a data structure that may be used to store analytic workspaces.

FIG. 14 is an exemplary illustration of a data structure that may be used to store analytic workspaces.

### DETAILED DESCRIPTION OF THE PREFERRED EMBODIMENT

The present invention provides the capability for multiple writers to make permanent changes to OLAP data while providing improved performance and ensuring data consistency. The present invention allows the application to store multiple OLAP objects in a single container, such that each OLAP object in the same container may be permanently modified by a session concurrent with another OLAP object being permanently modified by a different session. By allowing the OLAP objects within the container to be modified independently, the present invention eliminates much of the complication of having multiple containers (Analytic Workspaces) and the necessary duplication of data the multiple containers require. Moreover, since the OLAP objects in a single container share structural information, the structural information is automatically kept consistent for all OLAP objects in the container.

The multiple-writer database access of the present invention supports both optimistic and pessimistic locking of the modified data. If an OLAP application chooses an optimistic model, the application would allow the user to perform “what-if” modifications to the data without acquiring any locks. If the user later chooses to make his changes permanent, the user would be able to request a lock on the modified data and would obtain the lock if no other user has locked that data or has merged modifications to that data. Alternatively, an OLAP application can choose a pessimistic locking strategy and allow users to modify data only after successfully obtaining a lock on that data. Finally, an application is free to adopt a hybrid optimistic/pessimistic model by allowing a user to perform some “what-if” modifications to the data before obtaining a lock and then allowing further changes once the lock is obtained.

One aspect of the present invention is the breaking of the analytic workspace into smaller components, while still maintaining access and storage efficiency. Another aspect of the present invention is the coordination among users that need to merge different OLAP objects within the analytic workspace.

The breaking of the analytic workspace into smaller components is accomplished by a number of enabling changes to the underlying structure of the analytic workspace. Scalars are placed into a table and use the row-level insert capability of the underlying relational database management system (RDBMS) to modify them. Stored procedures are stored along with object data in another table. The multi-dimensional OLAP objects and sub-OLAP objects are broken out to be contained within their own storage.

To support the coordination between users, a number of new Stored Procedure Language statements are added. Commands are added to acquire and release write-locks on OLAP objects, sub-OLAP objects, and parts of the dimensional structures. Other new commands allow a user to revert back to the original value of some data or to view the latest data. More controls are provided to support the ability to make selective permanent changes to write-locked data.

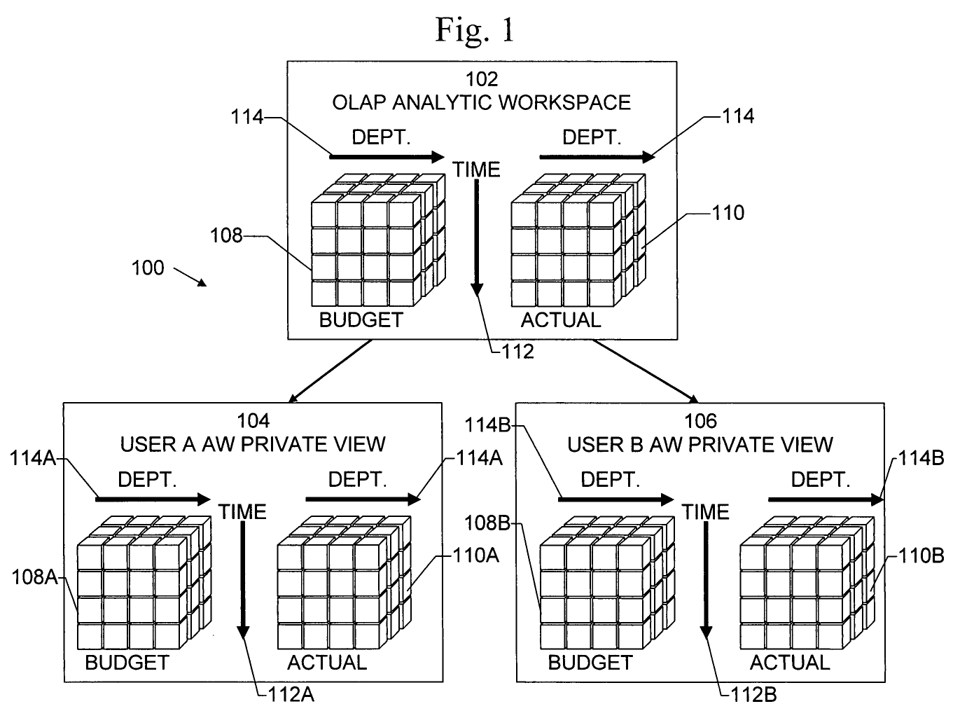

An example of an Online Analytical Processing (OLAP) database system 100 is shown in FIG. 1. A complete OLAP database system 100, may include a large number of data objects. FIG. 1 shows an example of several objects that may be included in complete OLAP database system 100. For example, OLAP database system 100 includes OLAP analytic workspace (AW) 102, which is a view of some of the committed (persistently stored) data in the OLAP database. When a user attaches an analytic workspace, a database private view of that analytic workspace is created for that user. Thus, OLAP database system 100 also includes a number of database private views of analytic workspaces (AWs), such as database private view 104, which is used by user A, and database private view 106, which is used by user B. OLAP database system 100 includes collections of objects, such as variables (objects that contain multidimensional data) and objects that describe that data, such as dimensions. For example, OLAP database view 102 is shown as including two variables, variable 108, for example, containing budgetary financial data, and variable 110, for example, containing actual financial data. The variables may be described by characteristics of the data they contain and by the number and type of dimensions. In this example, budget variable 108 and actual variable 110 may be dimensioned by time, dimension object 112, and department, dimension object 114. Note that for the purposes of this document, all OLAP objects are equivalent in terms of syntax and semantics as related to the present invention. Thus, the present invention is fully applicable to other OLAP objects, such as formulas, programs, aggregation maps, models, relations, value sets, etc., as well as to variables and dimensions.

An analytic workspace is a container for a collection of OLAP objects containing OLAP data and metadata. Each user that attaches an analytic workspace is given the capability to perform analytical processing on that data via a database private view that is assigned to him or created for him in OLAP system 100. A user is simply a software process or object to which a database private view has been assigned. Such a user may belong to a person, or it may belong to other software processes or objects. The present invention contemplates any type of user to which a database private view has been assigned.

In the example shown in FIG. 1, OLAP analytic workspace 102 is a view of the committed versions of two variables, budget 108 and actual 110, each of which has the dimensions time 112 and department 114. User A database private view 104 and user B database private view 106 each include a private view of those objects. For example, User A database private view 104 includes view 108A of variable budget, view 11OA of variable actual, view 112A of dimension time, and view 114A of dimension department. User B database private view 106 includes view 108B of variable budget, view 110B of variable actual, view 112B of dimension time, and view 114B of dimension department.

Each user having attached an analytic workspace can perform analytical processing, as desired, using the private view of the objects, such as variables and dimensions, contained in that user's database private view. In particular, a user can make temporary changes to its objects, such as by adding, deleting, or modifying data stored in one or more variables.

When a user wishes to make committed or persistent changes to objects, the changes must be merged back to the OLAP objects, which are shown in OLAP analytic workspace 102. When there are multiple users, the process of merging changes to the OLAP objects must be carefully controlled by OLAP database system 100. The present invention provides access modes for objects, which provides OLAP database system 100 with the capability to control the process of merging changes to the OLAP objects.

In the prior art, a user could attach an entire analytic workspace in read-only, read-write, or exclusive mode. That is, all objects in the analytic workspace were attached in the selected mode. In read-only mode, the user could make private changes to the data in the workspace to perform what-if analysis but could not commit any of these changes. In read-write and exclusive modes, a user would have to commit either all or none of the changes made to the workspace. Only one user could have the analytic workspace in read-write or exclusive mode at a time.

The present invention provides the capability for a user to attach an analytic workspace in a new multiple-writers mode. Once attached, the user can obtain each object in an analytic workspace in either read-only (not acquired) mode or read-write (acquired) mode. By default, none of the objects are acquired, which implies that no private changes to their data can be merged and therefore committed, which is useful when the objects are used for what-if analysis. A user can explicitly acquire each object, on an object-by-object basis, for read-write access. If an object is acquired, all changes to that object's data can be merged and later committed to the database.

Similar to non-multiwriter analytic workspaces, changes made to views of the objects in multiwriter analytic workspaces must be merged to the OLAP objects before they can be committed. In multiwriter mode, however, the user can choose which objects to merge and which ones not to merge. Hence, it is possible to commit changes to only a subset of acquired objects.

In a preferred embodiment, the present invention supports multiple readers/one writer access per workspace variables, dimensions, and valuesets for analytic workspaces attached in multiwriter mode. In another embodiment, it also supports multiple readers/one writer access per workspace programs, formulas, aggregation maps, etc. Users who attach an analytic workspace in multiwriter mode will “lock into” a consistent generation (version) of all objects as they were at the attach time.

For simplicity and clarity, the present invention will be described based on its handling of variables. However, this discussion is equally applicable to other OLAP objects, such as dimensions formulas, programs, aggregation maps, models, relations, value sets, etc.

After attaching an analytic workspace in multiwriter mode, all variables are automatically in read-only (not acquired) mode. Changes made to read-only variables are only what-if changes and cannot be merged and committed. To indicate the intention to make permanent changes, a user must acquire a variable. If the acquire succeeds, the database will ensure that the user will be able to merge the changes and then commit all merges. When the user is done modifying and merging a variable and does not wish to merge any further changes, it indicates so by releasing the variable.

Besides acquire, merge, and release, the present invention may provide users with two more useful commands: revert and resync. Both of these commands drop the private changes. Resync also refreshes the view of the data to the latest generation.

RESYNC—Refreshing to the Latest View (Generation) of Variables

At any time, a user will always be able to resync any variable to discard all read-only changes and promote the read-only variable to the latest generation. This is useful if a user wants to see the changes committed by another user since attaching the analytic workspace (or the last resync operation). It is important when using the resync functionality to keep in mind the logical relationship of different variables. One needs to be aware that the logical consistency of the data might be lost by promoting some variables and not the others to a new generation.

ACQUIRE—Acquiring a Variable for Read-Write Access

To merge changes made to the variable, the user must first acquire that variable. The user can try to acquire the variable with or without a resync operation. In any case, both forms of acquire command will fail if another user currently has the variable acquired.

ACQUIRE without RESYNC

If a user acquires the variable without a resync, all prior read-only changes are kept and now become “updatable” changes. The acquire operation without a resync will fail, however, if the user's generation of the variable is not the latest one (another user has updated that variable).

ACQUIRE with RESYNC

If a user acquires the variable with a resync, the prior read-only changes are discarded, and the variable is promoted to the latest generation. This operation is equivalent to a resync operation followed by an acquire without resync, except that both operations happen at the same time atomically. Hence, if a variable cannot be acquired even with resync, the resync will not happen.

Ensuring Data Consistency with ACQUIRE with CONSISTENT WITH

Often it is necessary to ensure that several variables stay consistent with each other. Hence, before modifying one of those variables, it is necessary to make sure that no one else is currently modifying some other variable. To provide consistency, when an object is Acquired, its lock is taken as a “writer”, which prevents anyone else from taking the lock as a “reader” or “writer”. When an object is listed in a CONSISTENT WITH clause, the object's lock is locked as “reader”, which prevents any other user from taking the lock as “writer”, but allows other “readers”. When all objects acquired during that ACQUIRE command are released, all “reader” locks of the CONSISTENT WITH objects are dropped, too.

RELEASE—Downgrading Acquired Variables to Read-Only Access

When a user is done modifying and merging a variable, the user should indicate so by releasing it. It will also be possible to release an acquired variable and therefore return it to read-only mode without performing a merge. Doing so would preserve all changes to the variable as private changes. If a variable has been merged but the changes have not been committed, the release command would not allow other users to acquire the variable until the user who merged the variable commits. Once a variable is released, it may be possible to reacquire it again later.

REVERT—Undoing Changes to a Variable

One would always be able to undo all changes made to a variable since the last merge, resync, acquire-with-resync, acquire-consistent-with or since attaching the analytic workspace (whichever happened last). In other words, the revert command reverts to the current generation of data as it exists in the permanent database storage. The revert operation works on read-only as well as acquired variables.

MERGE—Merging Variable Data to the Database Storage

Similar to the changes to read-write analytic workspaces, the changes to acquired variables must be merged (written) to the database permanent storage to become persistent. After merging one or more read-write analytic workspaces and/or acquired variables, a user may issue a commit operation to commit the transaction and thereby make the changes visible to other users. A user can select which acquired variables to merge.

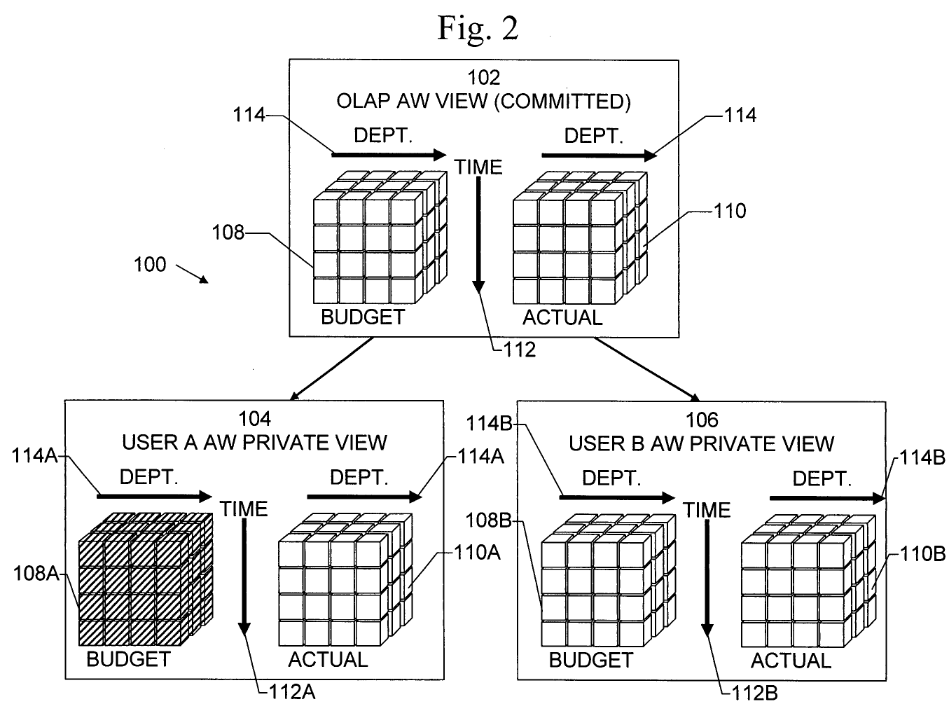

An example of a usage of the multiwriter features of the present invention based on the example shown in FIG. 1, is shown in FIGS. 2-x. As shown in FIG. 1, user A and user B have attached the OLAP analytic workspace 102, and the OLAP system 100 created for them database private views 104 and 106, respectively. In FIG. 1, by default, none of the objects are acquired. In FIG. 2, user A acquires variable budget 108A. This locks variable budget 108 in the analytic workspace 102 and prevents any other users, such as user B, from acquiring that variable. User A may then make changes to variable budget 108A, such as adding, deleting, or modifying data in variable budget 108A, with the assurance that any changes can be merged and committed to the OLAP variable 108 later. In the preferred embodiment of the invention, the acquisition of an object, such as a variable or a dimension, by a user has no effect on the lock status or ability to be acquired of any other objects. For example, even though variable budget is dimensioned by dimension time, the fact that user A has acquired variable budget 108A has no effect on the ability of user B to acquire dimension time 112B.

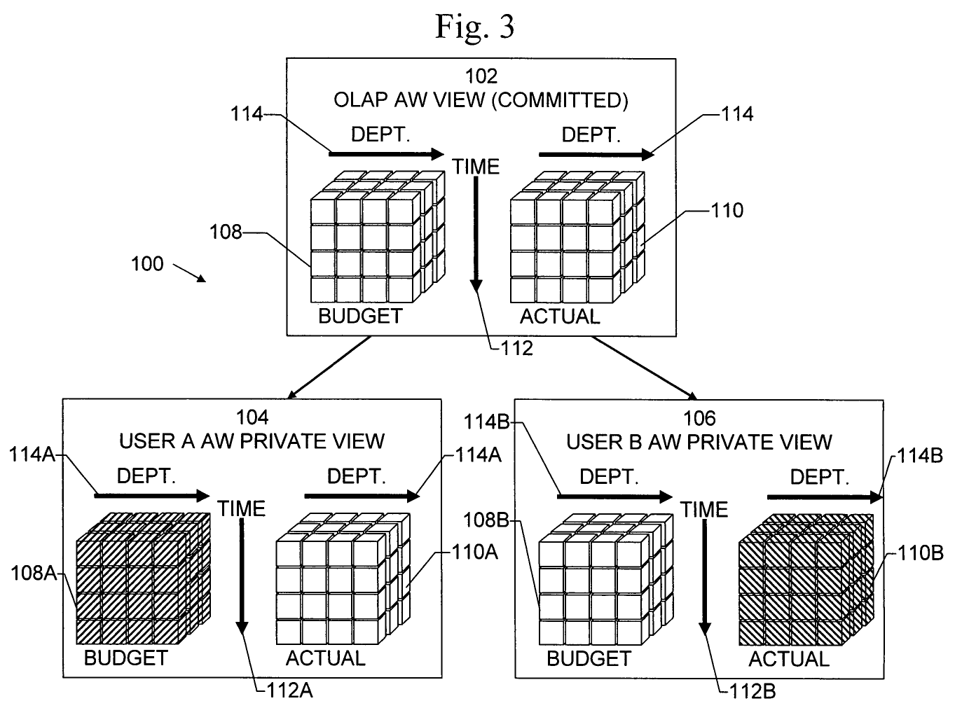

In FIG. 3, user B acquires variable actual 110B. This locks variable actual 110 in the analytic workspace 102 and prevents any other users, such as user A, from acquiring that variable. User B may then make changes to variable actual 110B, such as adding, deleting, or modifying data in variable actual 110B, with the assurance that any changes can be merged and committed to the OLAP variable 110.

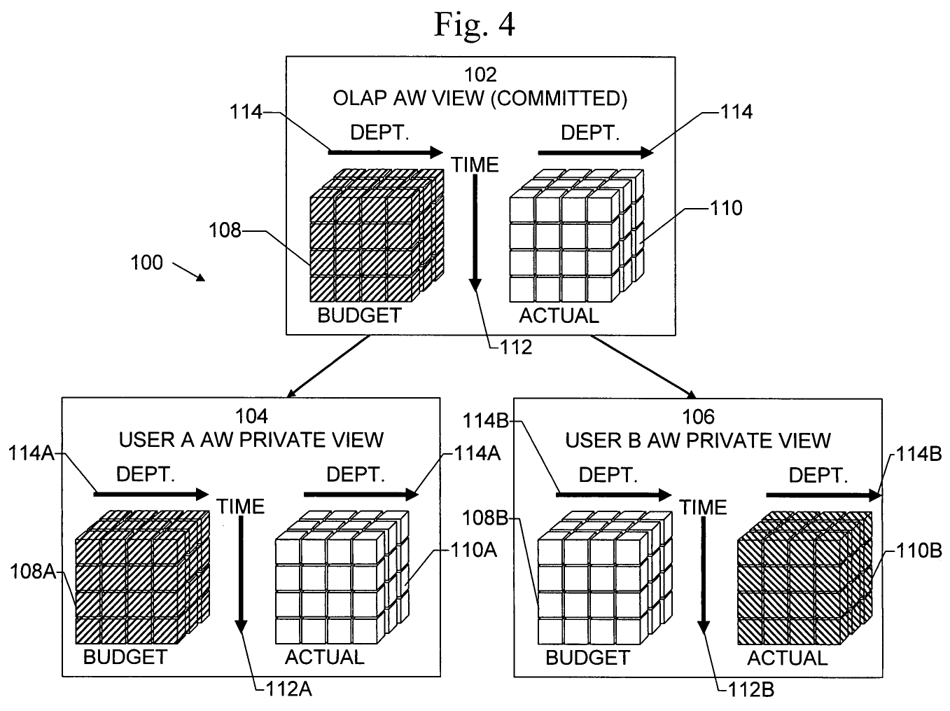

In FIG. 4, user A merges variable budget 108A and commits the changes to the OLAP variable budget 108 in analytic workspace 102. The committed analytic workspace now reflects changes made by user A. In addition, the generation (version) of variable budget 108 is incremented, since the committed data has changed.

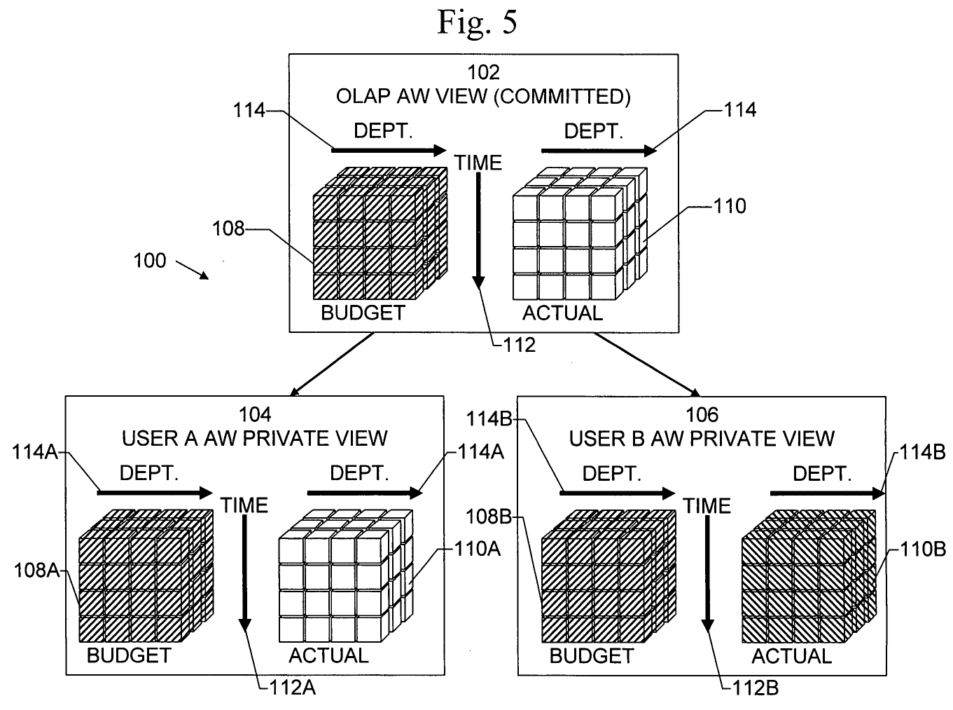

In FIG. 5, user B resyncs variable budget 108B. Resyncing refreshes his view of an object with the data in the committed version of the object in the analytic workspace. Thus, variable 108B is refreshed with the data in variable budget 108, which has previously been merged with changes made to variable budget 108A by user A.

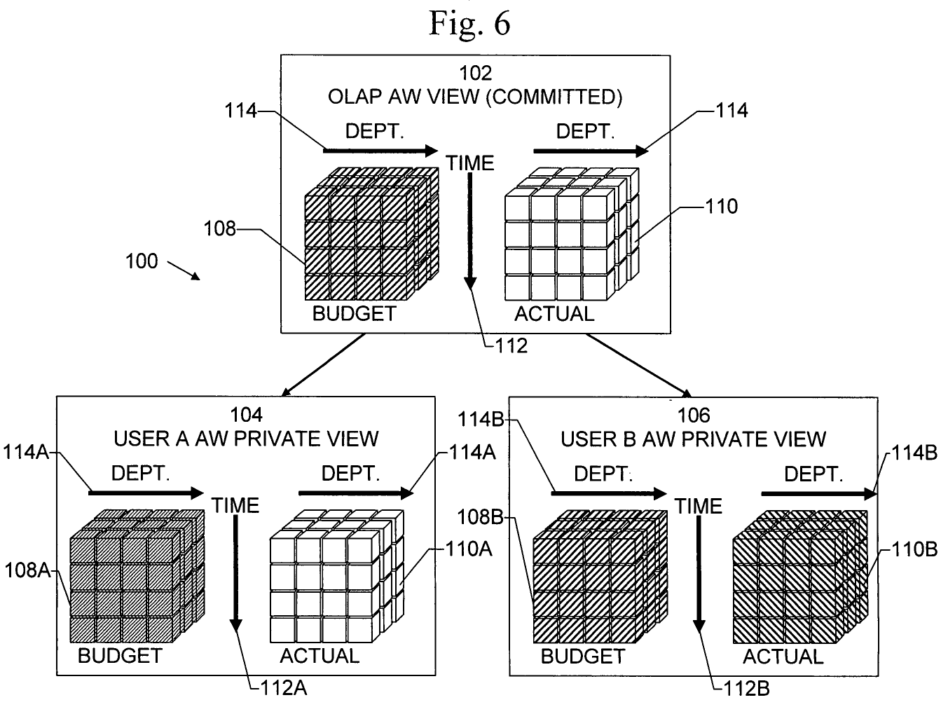

In FIG. 6, user A, which had previously committed changes to variable budget 108A, makes additional changes to variable budget 108A. User A then releases variable budget 108A, and user B releases variable actual 110B. Release downgrades the acquired objects that are being released to unacquired or read-only state. All prior changes made by a user to the objects are retained as private changes. Thus, user A retains the changes made to variable budget 108A, including the committed changes and the changes made since the commit, and user B retains the changes made to variable actual 110B, even though no changes to variable actual 110B were committed.

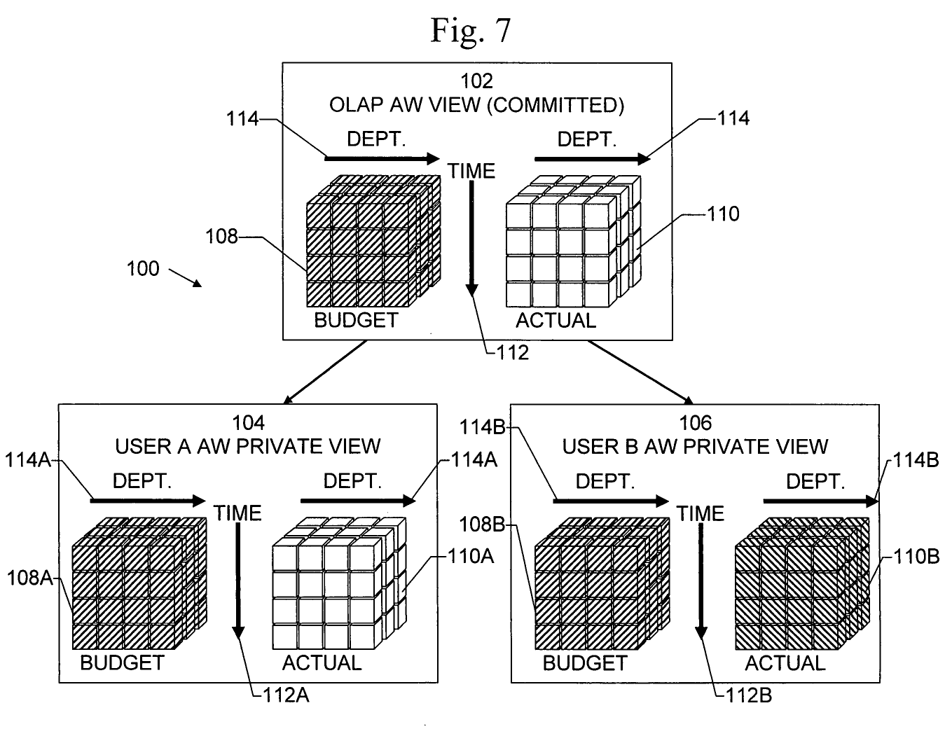

In FIG. 7, user A reverts variable budget 108A. This undoes the changes made to the variable since the last merge, resync, acquire-with-resync, acquire-consistent-with or since attaching the analytic workspace (whichever happened last). Hence, variable budget 108A is reverted to the committed version of data stored in the OLAP variable budget 108, since is it the version that user A resynched OLAP variable budget 108 last.

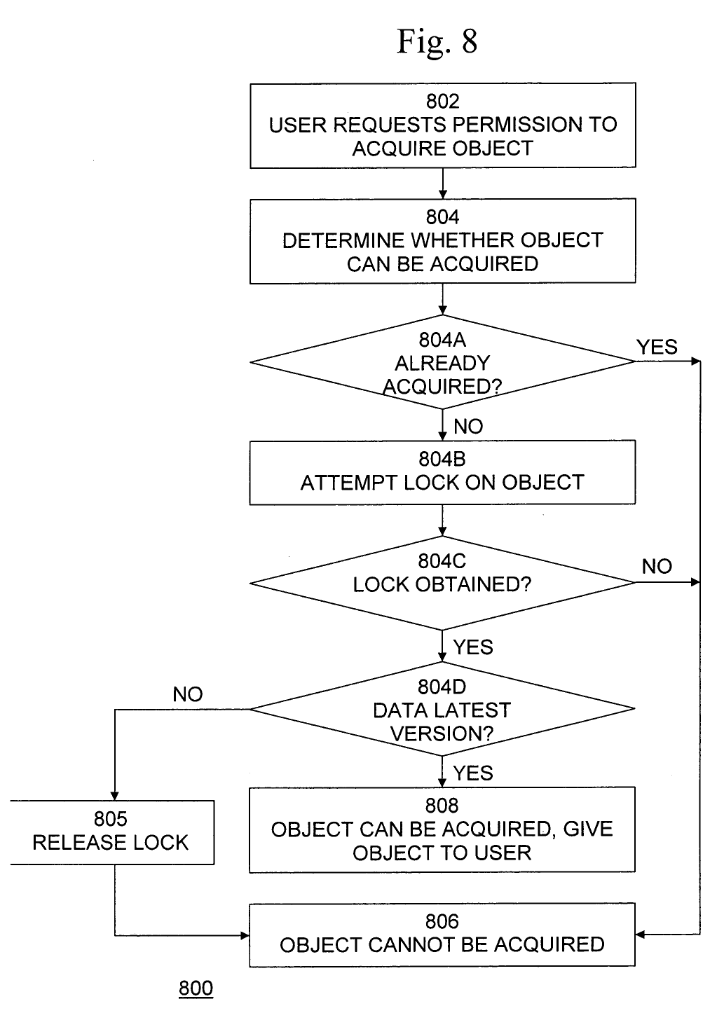

At any given time, a user who wants to acquire an object does not know whether that object can be acquired. The process 800 shown in FIG. 8 may be used by the system to determine whether a user can acquire an object. The process begins with step 802, in which a user requests permission to acquire an object from the OLAP database system. In step 804, the OLAP database system determines whether the user can acquire the requested object, including performing steps 804A and 804B. In step 804A, the OLAP database system determines whether the requested object has already been acquired by the requesting user. If the requested object has already been acquired by the requesting user, the requested object cannot be acquired for a second time contemporaneously with the first time and the process continues with step 806, in which the OLAP database system indicates to the requesting user that the object cannot be acquired.

Although, in a preferred embodiment, a user can only acquire an object once at any given time, in another embodiment, the user may be allowed to acquire an object multiple times. In such an embodiment, the user preferably would release the object the same number of times that the user has acquired the object, in order to actually release the user's lock on the object.

If the requested object has not already been acquired by the requesting user, then the process continues with step 804B, in which the user attempts to obtain a lock on the object and waits for the lock to be obtained up to a timeout that may be specified by the user. Although, preferably, this step is performed as a single operation, several sub functions are performed. In particular, the system may perform a number of checks, including whether some other user has acquired the object. For example, since there is a CONSISTENT WITH clause of ACQUIRE, this step could fail not only because the object could be ACQUIRED for update by another user, but also because the object could be acquired CONSISTENT (for reading and private what-if changes) with some other object by another user. In addition, if the checking performed by the system indicates that the object can be acquired, the system locks the object for the user.

In step 804C, it is determined whether the user successfully obtained the lock. If the user did not obtain the lock, the process continues with step 806, in which the OLAP database system indicates to the requesting user that the object cannot be acquired. If the user did obtain the lock, the process continues with step 804D, in which the OLAP database system determines whether the data contained in the requested object is the latest version, in order to ensure data consistency in the system. If the data contained in the requested object is not the latest version, the requested object cannot be acquired, and the process continues with step 805, in which the object is unlocked and, in step 805, the OLAP database system indicates to the requesting user that the object cannot be acquired. If the data contained in the requested object is the latest version, then the requested object can be acquired by the requesting user, and the process continues with step 808, in which the requesting user is given read/write control of the requested object.

Process 800 is a significant aspect of the present invention, as it is used to ensure data consistency as multiple users attempt to write to various objects in the OLAP database system. Process 800 may be used as part of an overall consistency model, which provides multi-user synchronization of the data. Examples of such consistency models include a pessimistic model and an optimistic model. In a pessimistic model, a user wanting to change an object in the OLAP database system acquires the object before making any changes to the view of that object in the user's database view. This way the user is ensured of the capability to merge and commit any changes made to the object. In an optimistic model, the user makes changes as desired to the view of the object in the user's database view without acquiring the object. Only when the user determines that he wants to commit the changes, does the user attempt to acquire the object. In an optimistic model, a user is not ensured of the capability to commit changes made to the object, but rather must expect that it will be possible to do so when desired.

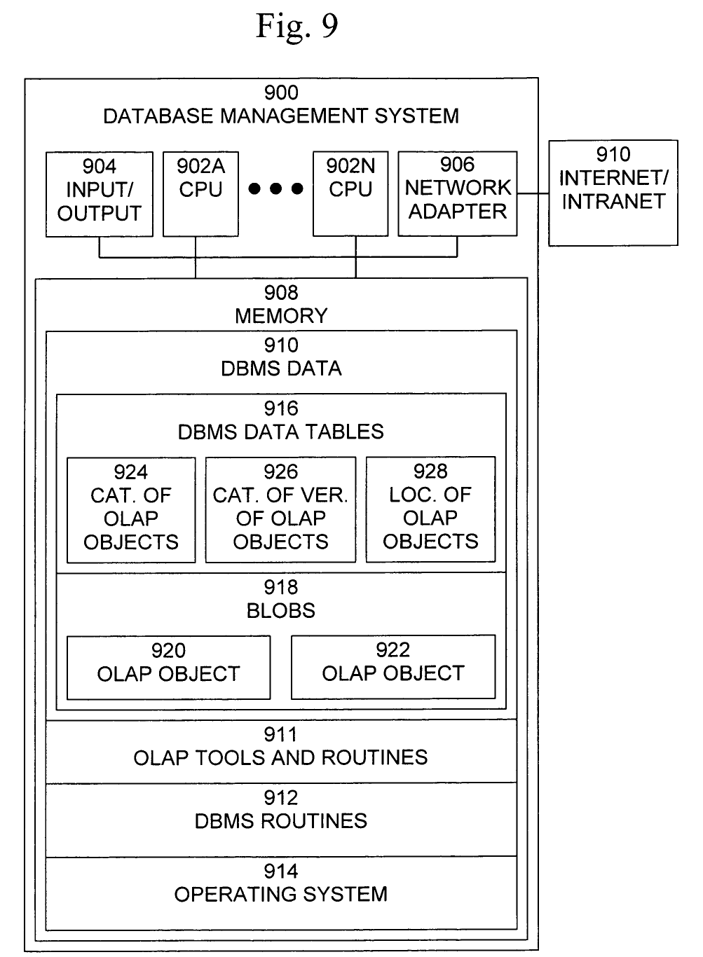

In the prior art, an OLAP system included an OLAP server between a client and a database management systems (DBMS). The OLAP server understood how data is organized in the database and had special functions for analyzing the data. In the present invention, no OLAP server is used. Rather, the present invention takes advantage of the power of modem database management systems, such as relational database management systems, to implement OLAP functionality directly in the DBMS. An exemplary block diagram of a database management system 900, in which the OLAP functionality of the present invention may be implemented, is shown in FIG. 9. Database management system 900 is typically a programmed general-purpose computer system, such as a personal computer, workstation, server system, and minicomputer or mainframe computer. Database management system 900 includes one or more processors (CPUs) 902A-902N, input/output circuitry 904, network adapter 906, and memory 908. CPUs 902A-902N execute program instructions in order to carry out the functions of the present invention. Typically, CPUs 902A-902N are one or more microprocessors, such as an INTEL PENTIUM® processor. FIG. 9 illustrates an embodiment in which database management system 900 is implemented as a single multi-processor computer system, in which multiple processors 902A-902N share system resources, such as memory 908, input/output circuitry 904, and network adapter 906. However, the present invention also contemplates embodiments in which database management system 900 is implemented as a plurality of networked computer systems, which may be single-processor computer systems, multi-processor computer systems, or a mix thereof.

Input/output circuitry 904 provides the capability to input data to, or output data from, database management system 900. For example, input/output circuitry may include input devices, such as keyboards, mice, touchpads, trackballs, scanners, etc., output devices, such as video adapters, monitors, printers, etc., and input/output devices, such as, modems, etc. Network adapter 906 interfaces database management system 900 with Internet/intranet 910. Internet/intranet 910 may include one or more standard local area network (LAN) or wide area network (WAN), such as Ethernet, Token Ring, the Internet, or a private or proprietary LAN/WAN.

Memory 908 stores program instructions that are executed by, and data that are used and processed by, CPU 902 to perform the functions of database management system 900. Memory 908 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 9, memory 908 includes database management system (DBMS) data 910, OLAP tools and routines 911, DBMS routines 912, and operating system 914. DBMS data 910 includes DBMS data tables 916 and binary large objects (BLOBs) 918. BLOBs 918 include a plurality of BLOBs. Each OLAP object is stored separately from other OLAP objects in one or more BLOBs. That is, each BLOB only includes data belonging to one OLAP object. For example, a first OLAP object 920 may be stored in one or more BLOBs, while a separate OLAP object 922 may be stored in one or more different BLOBs. DBMS data tables 916 include a plurality of database tables, such as relational database tables, including tables that store information about the state of the OLAP database system. Examples of such database tables include database table 924, which stores a catalog of OLAP objects present in the OLAP database system, database table 926, which stores a catalog of version information about OLAP objects present in the OLAP database system, and database table 928, which stores information about locations of OLAP objects present in the OLAP database system. In addition to these examples, many other types of information about the OLAP database system may be stored in database tables included in DBMS database tables 916.

OLAP tools and routines 911 include software tools, routines, interfaces, etc. that provide OLAP functionality. OLAP tools include software tools for performing various analyses on data stored in OLAP objects, such as variables. OLAP routines include software that implements the functions of multiwriter access according to the present invention. DBMS routines 912 provide the functionality of DBMS in which the OLAP system is implemented, such as low-level database management functions, such as those that perform accesses to the database and store or retrieve data in the database. Such functions are often termed queries and are performed by using a database query language, such as Structured Query Language (SQL). SQL is a standardized query language for requesting information from a database. OLAP tools and routines 911 provide OLAP functionality using DBMS routines 912 to access and store or retrieve data in the database. For example, OLAP tools and routines 911 may use SQL queries to add, delete, or modify data in OLAP objects that are stored in DBMS data tables 916 and/or BLOBs 918. Operating system 914 provides overall system functionality.

An advantage of the above-described architecture is that the OLAP database system may be implemented using DBMS functionality and commands. This allows the OLAP database system to take advantage of the inherent power and performance of the DBMS, while still providing complete OLAP functionality, including the multiwriter functionality. In addition, the architecture obviates the need for a separate OLAP server connected to a DBMS and provides improved performance due to the elimination of the need to transfer large amounts of data between the OLAP server and the connected DBMS.

As shown in FIG. 9, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

Additional enhancements may be made to the OLAP database system of the present invention. For example, dimensions are OLAP objects that may be modified and manipulated by users. Typically, dimensions include data that is relatively sparse. In order to improve performance and reduce storage requirements when dealing with sparsely populated dimensions, the present invention may use what are termed composite dimensions. Composite dimensions are dimension tuples that include only data that is actually present in the dimension. The OLAP database system of the present invention generates and numbers dimension tuples, which, when combined, provide a dimension object that includes of the data that is actually present in the dimension. In the case in which a particular data value of a dimension is present in more than one dimension tuple and multiple users generate or modify that value, the multiple dimensions involved should be resynced in order to maintain consistency.

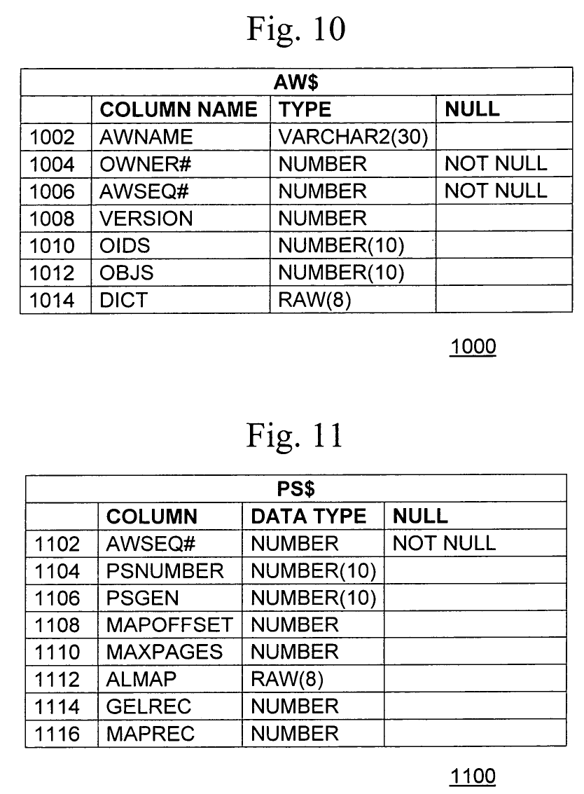

FIGS. 10-14 illustrate examples of data structures that may be used to store analytic workspaces. An example of an AW$ Table 1000 is shown in FIG. 10. The AW$ table is the first table involved in tracking analytic workspaces. Its primary purpose is to describe all the analytic workspaces in the database. It has one row per analytic workspace.

The AWNAME column 1002 describes the name of the analytic workspace. It is used to generate a table name where the actual data are stored. The OWNER# column 1004 identifies the schema where the data are stored. The AWSEQ# column 1006 contains a unique number used as a foreign key in the other tables. The VERSION column 1008 contains a version number describing the rest of the storage. The remaining three columns 1010, 1012, and 1014 identify special page spaces used in the object management of the analytic workspace.

An example of a PS$ Table 1100 is shown in FIG. 11. The PS$ table 1100 is used to track page spaces in the system. The AWSEQ# column 1102 contains the foreign key relating the PS$ table to the AW$ table. PSNUMBER column 1104 contains a unique value indicating a specific page space in the system. The PSGEN column 1106 increments with each MERGE, although only those page spaces that are merged will be incremented. Different page spaces will have different generation numbers; a current view of the AW is the maximum generation of each pagespace. The MAPOFFSET column 1108 is the offset into the appropriate map for the start of the map. The MAXPAGES column 1110 is the number of pages in the space. The ALMAP column 1112, GELREC column 1114, and MAPREC column 1116 contain the record numbers for the location of the allocation bitmap, the pending erase list bitmap, and the map space for the BLOB respectively. These columns refer to the page space specific BLOBs.

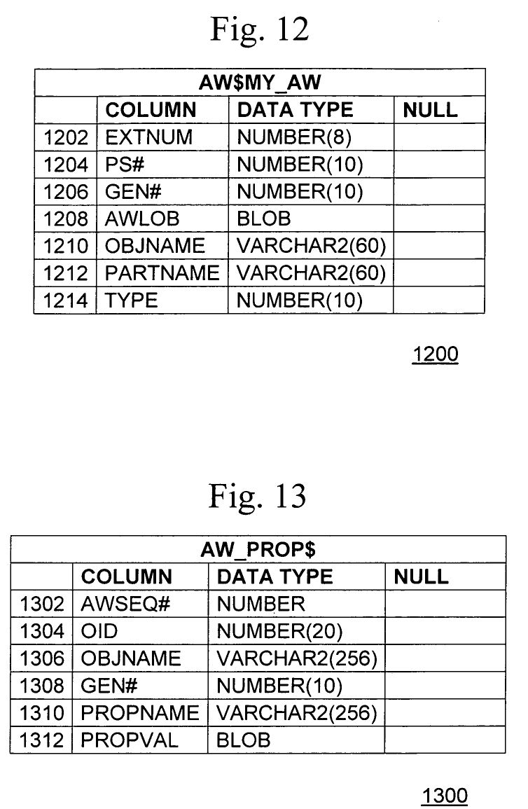

An example of an AW$MY_AW 1200 is shown in FIG. 12. The AW$ my_aw table1200 holds the actual data BLOBS for extents of a page space. The EXTNUM column 1202 allows multiple (ordered) extents to make up a single analytic workspace, each extent stored in the corresponding AWLOB column 1208 and AWLOB. They will also contain the page space generation erase list for the column. The additional columns 1206, 1208 track the number of the page space and the generation of the row. A null generation will be used to store the extent data; non-null generation will contain the generation erase list for that generation's corresponding extent data. The partname row 1210 is used for partitioning.

There is a single system-wide property table (AW_PROP$), which keeps all properties for all OLAP objects in the database. (A property is a named text field that can be associated with an OLAP object. There can be any number of properties per object.) An example of an AW_PROP$ table 1300 is shown in FIG. 13. The AWSEQ# column 1302 contains the foreign key relating the PS$ table to the AW$ table. The OID column 1304 contains an identifier of the object. The OBJNAME column 1306 and the GEN# column 1308 contain the name of the variable and the generation number. The PROPNAME column 1310 contains the name of the property, while the PROPVAL 1312 column contains the values of the property.

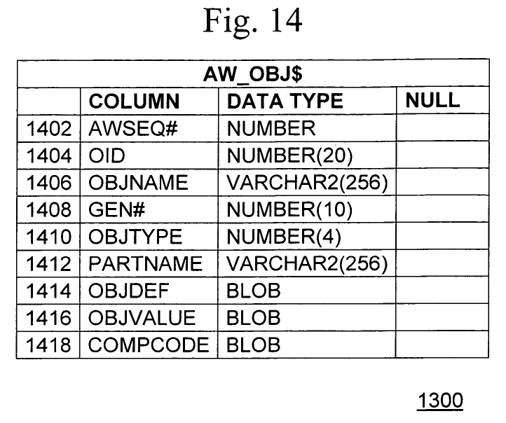

Instead of having per-user scalar variable tables, in the preferred embodiment there is a single system-wide AW_OBJ$ table to store the definitions of all OLAP objects in the database (for all users and all AWs). An example of an AW_OBJ$ table 1400, is shown in FIG. 14. The AWSEQ# column 1402 is the standard foreign key to describe the analytic workspace. The OID column 1404 contains an identifier of the object. This value will be used primarily to coordinate enqueue support. Similarly, the OBJNAME column 1406 and the GEN# column 1408 contain the name of the variable and the generation number. The PARTNAME row 1412 is used for partitioning. The OBJDEF column 1414 contains the definition of the object, while the OBJVALUE 1416 column contains the values stored in the object. The COMPCODE column 1418 holds the text and compiled code (the AW SPL is a p-code based language) for executable objects (programs, formulas, models). By storing them independently, they also may be independently modified.

During each MERGE command (no matter if it is an MERGE of an entire analytic workspace by a read/write user or an MERGE of several objects by a multiwriter user), a new version of an Analytic Workspace is produced. That version is written into PS$ table as a row with the given AWSEQ#, NULL PSNUMBER, and the new PSGEN being the new AW generation. Then, all changed page spaces, objects, and properties get new rows in the appropriate tables featuring the new generation number (called, GEN# in AW_OBJ$, AW_PROP$, and AW$name tables and PSGEN in PS$ table). When a page space, object, or property is deleted, such a delete is actually treated as any other “modification”, and a row indicating “deleted” is inserted into the appropriate table just as if it were a modification.

Hence, at any time, when one needs to find an appropriate row in any table that represents the state of a page space, object, or property at generation X, they need to find a row that represents the needed page space, object, or property that has the largest Generation Number not greater than X.

For example, suppose there are rows with the following GEN# values in table AW_OBJ$ where AWSEQ# is the desired AW sequence number and OID is the desired object ID in that AW: 1, 3, 5, 9.

Then, for AW generation 3, to find the definition of the object, the system must access the row with GEN# =3. For AW generation 2, however, the system must access the row with GEN#=1. For AW generation 7, the system must access the row with GEN#=5 (largest GEN# that is not greater then 7).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A database management system comprising:
a database containing a plurality of objects; and
a plurality of database private views, each database private view containing a view of at least some of the plurality of objects in the database;
wherein a view of an object in a database private view is based on one of the plurality of versions of the corresponding object in the database; and
wherein changes made to a view of an object in a database private view are not written to a corresponding object in the database unless write access on the object has been given to the database private view; and
wherein the database management system is operable to give write access on each of the plurality of objects in the database to database private views individually.

2. The system of claim 1, wherein the database management system is operable to give write access on an object upon request from a user of a database private view.

3. The system of claim 2, wherein the database management system is further operable to determine whether write access on the object can be given, in response to the request from the user of the database private view.

4. The system of claim 3, wherein the database management system is further operable to give write access on an object to a database private view that already contains a plurality of changes made to that object's view.

5. The system of claim 4, wherein the database management system is further operable to preserve changes made to an object's view, while giving write access on the object to a database private view, so that these changes, along with a plurality of further changes, can be written to that object in the database.

6. The system of claim 5, wherein the database management system is further operable to determine whether write access on the object can be given by determining whether the write access on the object has already been given to the database private view, by determining whether the write access on the object has already been given to another database private view, and by determining whether data in the object is a latest version.

7. The system of claim 1, wherein the database management system is further operable to refresh a view of an object in a database private view with another version of the object in the database.

8. The system of claim 7, wherein the database management system is further operable to refresh a view of an object in a database private view with the latest version of the object in the database.

9. The system of claim 8, wherein the database management system is further operable to undo changes made in a view of an object in a database private view.

10. The system of claim 4, wherein the database management system is further operable to give write access on an object in the database while preventing other database private views from obtaining write access on at least one other object in the database.

11. The system of claim 4, wherein the database management system is further operable to remove write access on a database object on which write access has been given.

12. The system of claim 1, wherein each object is a variable, a measure, a cube, a dimension, a formula, a program, a procedure, an aggregation plan, a model, a relation, a saved selection, a worksheet, a table, an index, an abstract data type, or a large object.

13. A database management system, in which an online analytical processing system is implemented, comprising:
a plurality of database data structures storing a plurality of online analytical processing objects;
a plurality of database management routines operable to access the database data structures; and
a plurality of online analytical processing tools operable to perform online analytical processing functions on the online analytical processing objects using the database management routines.

14. The system of claim 13, wherein the database management system is a relational database management system.

15. The system of claim 14, wherein the database data structures include database data tables and binary large objects.

16. The system of claim 15, wherein at least some of the online analytical processing objects are stored in binary large objects.

17. The system of claim 16, wherein each binary large object stores information relating to only one online analytical processing object.

18. The system of claim 17, wherein the database data tables store information about the state of the online analytical processing system.

19. The system of claim 18, wherein the plurality of online analytical processing objects implement an online analytical processing database containing a plurality of objects; and
the plurality of database data structures further store a plurality of database private views, each database private view containing a view of each of at least some of the plurality of objects in the online analytical processing database;
wherein changes made to a view of an object in a database private view are not written to a corresponding object in the online analytical processing database unless write access on the object has been given to the user of the database private view; and
wherein the online analytical processing system is operable to give write access on each of the plurality of objects in the online analytical processing database to database private views individually.

20. The system of claim 19, wherein the online analytical processing system is operable to give write access on an object upon request from a user of a database private view.

21. The system of claim 20, wherein the online analytical processing system is further operable to determine whether write access on the object can be given, in response to the request from a user of the database private view.

22. The system of claim 21, wherein the online analytical processing system is further operable to give write access on an object to a database private view that already contains a plurality of changes made to that object's view.

23. The system of claim 22, wherein the online analytical processing system is further operable to preserve changes made in an object's view, while giving write access on the object to a database private view, so that these changes, along with a plurality of further changes, can be written to that object in the online analytical processing database.

24. The system of claim 23, wherein the online analytical processing system is further operable to determine whether write access on the object can be given by determining whether the write access on the object has already been given to the database private view, by determining whether the write access on the object has already been given to another database private view, and by determining whether data in the object is a latest version.

25. The system of claim 24, wherein the online analytical processing system is further operable to refresh a view of an object in a database private view with another version of the object in the online analytical processing database.

26. The system of claim 25, wherein the online analytical processing system is further operable to refresh a view of an object in a database private view with the latest version of the object in the online analytical processing database.

27. The system of claim 24, wherein the online analytical processing system is further operable to undo changes made in a view of an object in a database private view.

28. The system of claim 25, wherein the online analytical processing system is further operable to give write access on an object in the online analytical processing database while preventing other database private views from obtaining write access on at least one other object in the online analytical processing database.

29. The system of claim 20, wherein the online analytical processing system is further operable to remove write access on an object in the online analytical processing database to which write access has been given.

30. The system of claim 21, wherein each object is a variable, a measure, a cube, a dimension, a formula, a program, a procedure, an aggregation plan, a model, a relation, a saved selection, a worksheet, a table, an index, an abstract data type, or a large object.
